(19) United States
(12) Patent Application Publication
(10) Pub. No.: US 2005/0136983 A1
(43) Pub. Date: Jun. 23, 2005

(54) Automated local weather reports for display on cellular phones

(75) Inventors: Ciprian Agapi, Lake Worth, FL (US); Vanessa V. Michelini, Boca Raton, FL (US); Wallace J. Sadowski, Boynton Beach, FL (US)

Correspondence Address: CHRISTOPHER & WEISBERG, PA, 200 E LAS OLAS BLVD, SUITE 2040, FT LAUDERDALE, FL, 33301, US

(73) Assignee: International Business Machines Corporation, Armonk, NY (US)

(21) Appl. No.: 10/744,254

(22) Filed: Dec. 22, 2003

(51) Int. Cl. H04M 1/00

(52) U.S. Cl. 455/566

(57) ABSTRACT

A system and method provide automated local weather reports for display on wireless communication devices such as telephones. The system provides information for display on a wireless communication device by establishing a communications link with the wireless communication device, determining its location, and transmitting content to it related to its location, such as meteorological information.

### BACKGROUND OF THE INVENTION

1. Statement of the Technical Field

The present invention relates to the field of communication and more particularly to wireless information networks.

2. Description of the Related Art

Wireless communication devices, such as telephones, pagers, and personal digital assistants (PDA's) continue to grow in popularity and use. Concurrent with the evolution of wireless devices, communication and information services have become more sophisticated. In addition to providing voice communication and voice messaging, available services offer text messaging, e-mail, and Internet browsing, among others.

Information on demand services using a telephone network have long been popular with respect to land-line based services, as well as wireless services. One example of such a service includes a dial-in number that an information seeker or a service subscriber can call to listen to a recorded voice message. Exemplary messages include motion picture start times, weather forecasts, traffic conditions, stock quotes, sports scores, and the like. However, a significant disadvantage of the dial-in service is that a subscriber must proactively dial the service number each time information is desired. This is particularly undesirable when information changes or is updated frequently, or when a subscriber wishes to learn of an event as soon as it happens. Further, a subscriber or information seeker must look-up, know, or store the telephone number to the specific service. Although a service user may know or store the telephone number of an information provider for a “home” region, such services are only used with difficulty outside of the home region.

In another information delivery model, a subscriber can identify content of interest with an information provider. The content of interest can be provided in voice, text or graphical form to the subscriber, upon demand by the subscriber, by requesting an information “update,” or by the content provider at scheduled intervals or as information becomes available. This model of information delivery is especially well suited to text and graphics capable devices. Although such a model improves upon the telephonic dial-in model by providing more timely information, there are still deficiencies in the services provided, especially for the itinerant subscriber.

For example, should a subscriber have an interest in information related to the location where the subscriber is situated at a given instant, such as a local weather forecast, the subscriber would need to know his or her location, access the content selection feature of the service, and attempt to match the present location to a new content selection. This is obviously not possible if the subscriber is not sure of her or his location. Further, even if present location is known, updating content selections in relation to present location is tedious at best.

### SUMMARY OF THE INVENTION

The present invention addresses the deficiencies of the art in respect to easily and automatically obtaining personalized and localized information of interest from service providers and provides a novel and non-obvious method, system and apparatus for obtaining automated local weather reports for display on wireless communication devices such as telephones.

In an exemplary method, a system provides information for display on a wireless communication device by establishing a communications link with a wireless communication device, determining its location, and transmitting content to it related to its location. The content, as well as its delivery schedule, can be established by the device or by the system.

Systems consistent with the present invention include a push server in communication with a content database, a personalization server in communication with the push server, a personalization service in communication with the personalization server, a location server having a location database in communication with the personalization service, and a wireless gateway in communication with the location server and the personalization server.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of the specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is graphical representation of a subscriber traveling through different locations served by a communication and information services network; and

FIG. 2 is a representation of details of the communication and information services network illustrated in FIG. 1.

### DETAILED DESCRIPTION OF THE PREFERRED EMBODIMENTS

The present invention provides a system and method for combing location-based services with personalized, “push” content. The system and method can provide pushed content based on the combination of location and a set of personalization parameters (or content filters) that are unique to each system user or service subscriber (hereinafter “subscriber”) having a wireless communications device, such as a telephone, text messenger, beeper, PDA or the like. In an exemplary application, a subscriber has configured the device to permit the system to “push” meteorological information to the device in graphical and/or textual formats with respect to a specific, limited geographical area. Exemplary information includes current conditions, forecast conditions, and trend data.

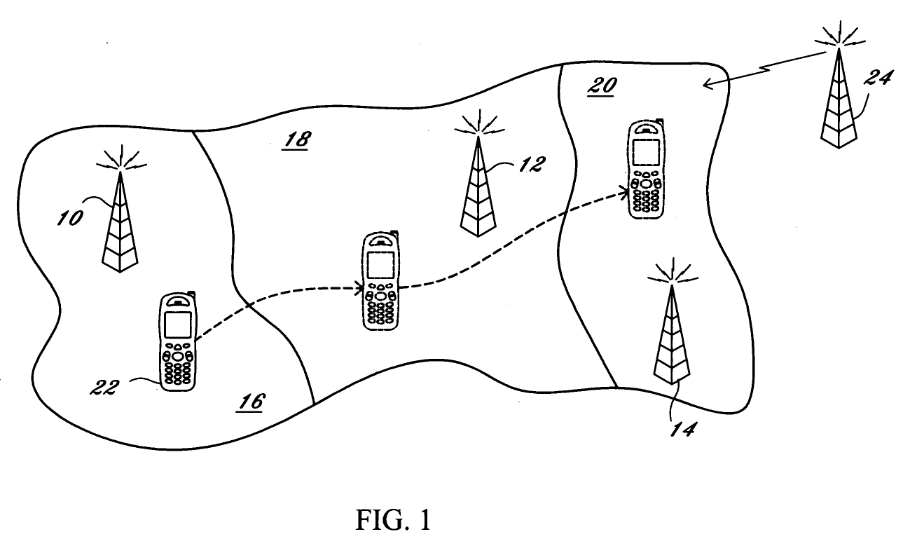

Referring now to FIG. 1, an exemplary region of a communication system is graphically represented, wherein one or more relay stations or transmitters 10, 12, and 14 are located in generally defined geographical areas 16, 18, 20, respectively, as is known in the art to provide communication service in the region. A subscriber 22 is shown in area 16. Movement of the subscriber 22 from area 16 to area 18 and to area 20 is shown in dashed lines. Each transmitter is in communication with other transmitters, as is known in the art, to provide information from a central broadcast or transmission facility 24.

As the subscriber 22 moves within an area, or from one area to another, the subscriber is able to use a communication device in a manner such that the location of the subscriber makes no difference in how the communication device is used or what information is obtained. Transmissions and receptions are directed to, or routed between, transmitters and the central broadcast facility using techniques known in the art that are completely invisible to the subscriber.

However, as the subscriber has configured the device to permit the system to “push” meteorological information to the device related to the location of the subscriber, the location of a subscriber within an area, or relative proximity with respect to a specific transmitter, affects the information provided to the subscriber. Specifically, when the subscriber 22 is in area 16, or closer to transmitter 10 than to transmitters 12 and 14, the subscriber can be provided with content that relates to area 16 or the vicinity of transmitter 10, even if signals transmitted to the communication device do not emanate from transmitter 10.

In the example, the subscriber is provided with weather information for area 16 or the vicinity of transmitter 10 that is presented on a mobile phone display as long as: 1) the mobile phone is “on” and 2) the mobile phone is receiving a signal from an identifiable transmitter. This system identifies the transmitter, obtains weather information for the location or area associated with the transmitters, such as a zip code or other location parameter, and transmits the weather information to the mobile phone for automatic display.

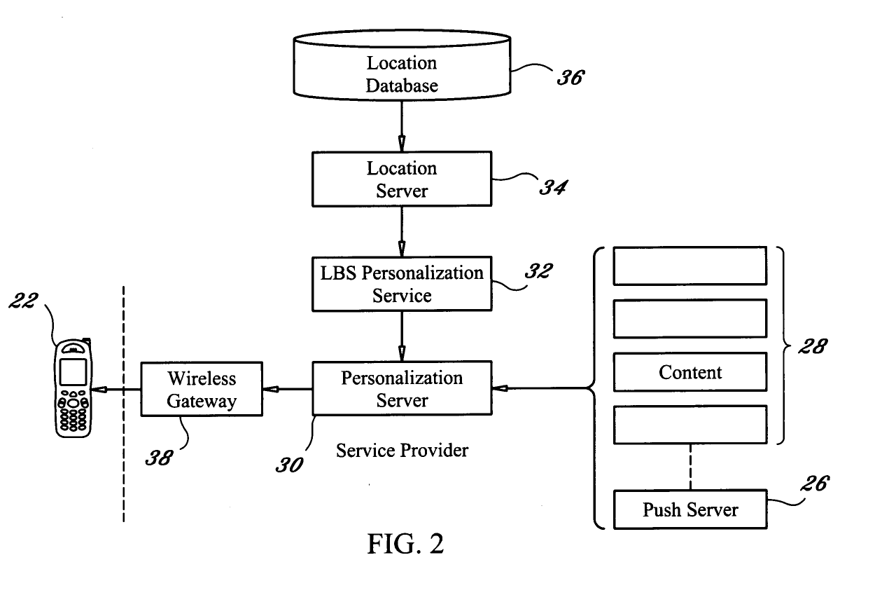

The system is better understood by reference to FIG. 2 which shows details of the communication and information services network illustrated in FIG. 1. A push server 26 is in communication with a content database 28 and a personalization server 30 that exchanges information with a location based service personalization service 32. The personalization service 32 exchanges information with a location server that includes or is in communication with a transmitter location database 36. The location server directs push content 28 from the personalization server 30 to a wireless gateway 38 (transmitter) which transmits the content to the subscriber 22.

Thus, the system provides current, desired information for the subscriber's location without the subscriber having to take any action, such as placing a call, or even knowing his or her location because the subscriber's location is determined by identifying the transmitter that is interacting with the communication device.

An additional feature of the invention is that the system can track or identify the position of a subscriber without global positioning satellite (GPS) tracking or subscriber interaction. For example, a fleet of trucks can employ the system to automatically provide drivers with current, local weather and road conditions, while at the same time monitoring the location of the vehicles in the fleet.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. A method of providing information for display on a wireless communication device, comprising the steps of:
establishing a communications link with a wireless communication device;
determining the location of the wireless communication device; and
transmitting content related to the location of the wireless communication device to the wireless communication device.

2. The method of claim 1, further comprising the step of filtering transmitted content related to the location of the wireless communication device with the wireless communication device.

3. The method of claim 1, further comprising the step of filtering content before transmitting content related to the location of the wireless communication device to the wireless communication device.

4. The method of claim 1, wherein the wireless communication device is capable of displaying content including graphics, text and images.

5. The method of claim 4, wherein the content includes current, local, meteorological conditions.

6. The method of claim 4, wherein the content includes current, local, traffic conditions.

7. The method of claim 1, wherein content is transmitted to the wireless communication device continuously.

8. The method of claim 1, wherein content is transmitted to the wireless communication device at predetermined intervals.

9. The method of claim 1, wherein content is transmitted to the wireless communication device when content changes.

10. A method of providing local weather reports for display on a wireless communication device, comprising the steps of:
establishing a communications link with a wireless communication device capable of displaying content including graphics, text and images;
determining the location of the wireless communication device; and
transmitting meteorological data related to the location of the wireless communication device to the wireless communication device based upon predetermined transmission parameters.

11. A system for providing localized information comprising:
a push server;
a content database in communication with the push server;
a personalization server in communication with the push server;
a personalization service in communication with the personalization server;
a location server having a location database in communication with the personalization service; and
a wireless gateway in communication with the location server and the personalization server.

12. A computer-readable storage medium storing a computer program which when executed performs a method for providing localized content to a wireless communication device comprising:
determining the location of a wireless communication device; and
transmitting content related to the location of the wireless communication device to the wireless communication device.
